(19) United States
(12) Patent Application Publication
(10) Pub. No.: US 2015/0113398 A1
(43) Pub. Date: Apr. 23, 2015

(54) METHOD FOR INPUTTING CHARACTERS, TERMINAL, AND RECORDING MEDIUM

(71) Applicant: Taewoo Kim, Seoul (KR)

(72) Inventor: Taewoo Kim, Seoul (KR)

(73) Assignee: NEOWIZ INTERNET CORPORATION, Seongnam-si, Gyeonggi-do (KR)

(21) Appl. No.: 14/234,318

(22) PCT Filed: Jul. 17, 2012
(86) PCT No.: PCT/KR2012/005692

§ 371 Date: Mar. 14, 2014

(30) Foreign Application Priority Data
Jul. 22, 2011 (KR) 10-2011-0072979

(51) Int. Cl. G06F 3/0488; G06F 3/0482

(52) U.S. Cl. CPC G06F 3/0488; G06F 3/0482
USPC 715/709

(57) ABSTRACT

The present invention relates to a character input technology, and more particularly, to a character input technology for enabling a user to input the characters without watching a screen and for maximally reducing the occurrence of typing errors during the inputting of the characters.

### TECHNICAL FIELD

The present invention relates to a technology of inputting characters.

### BACKGROUND ART

Conventionally, terminals, such as a mobile communication terminal, a smart phone, a tablet PC, a PDA, and the like, display a virtual keypad including buttons where characters are displayed through a touch screen, and processes inputting of a character displayed on a predetermined button when the predetermined button is touched by a user from among the buttons included on the displayed virtual keypad.

As described above, according to a conventional character inputting scheme using a touch screen, a user needs to input characters while constantly viewing the displayed virtual keypad and, thus, it is inconvenient for the user to input characters while moving.

Also, the terminals, such as a mobile communication terminal, a smart phone, a tablet PC, a PDA, and the like have a small touch screen and the buttons included on the virtual keypad displayed on the touch screen are also small and, thus, there is a drawback in that typographical errors frequently occur by touching incorrect buttons.

### DETAILED DESCRIPTION OF THE INVENTION

With the above described background in mind, the present invention provides a character input technology for a user to input characters without viewing a screen.

Also, the present invention provides a character input technology for maximally reducing a probability of a typographic error while characters are input.

In accordance with an aspect of the present invention, there is provided a terminal for inputting characters, the terminal including: a touch recognition unit that recognizes one or more pieces of information from among original orientation information and reorientation number information for a sliding touch of a user on a touch screen; and a character input processing unit that determines, to be an input character, a character allocated to correspond to the one or more pieces of recognized information from among the original orientation information and reorientation number information, and processes inputting.

In accordance with another aspect of the present invention, there is provided a character input method, the character input method including: a step of recognizing one or more pieces of information from among original orientation information and reorientation number information for a sliding touch of a user on a touch screen; a step of determining, to be an input character, a character allocated to correspond to the one or more pieces of recognized information from among the original orientation information and reorientation number information; and a step of processing the input of the character determined to be the input character.

In accordance with another aspect of the present invention, there is provided a computer-readable recording medium that records a program for implementing the character input method, the computer-readable recording medium that records the program implementing: a function of recognizing one or more pieces of information from among original orientation information and reorientation number information for a sliding touch of a user on a touch screen; and a function of determining, to be an input character, a character allocated to correspond to the one or more pieces of recognized information from among the original orientation information and reorientation number information, and processing inputting.

In accordance with another aspect of the present invention, there is provided a terminal for inputting characters, the terminal including: a touch pattern information recognizing unit that recognizes touch pattern information associated with a touch of a user on a touch screen; and a character input processing unit for determining a character corresponding to the recognized pattern information to be an input character, and processing inputting.

In accordance with another aspect of the present invention, there is provided a terminal for inputting characters, the terminal including: a touch area allocating unit that allocats, to a touch screen, a separate touch area for inputting characters; and a character displaying unit that displays characters in surroundings or around the circumference of the allocated touch area, and displays the characters in different locations.

In accordance with another aspect of the present invention, there is provided a terminal for inputting characters, the terminal including: a touch reorientation number recognizing unit that recognizes a number of reorientations of a touch of a user on a touch screen; and a function executing unit that executes a function corresponding to the recognized reorientation number information, from among functions defined for respective bits of reorientation number information.

In accordance with another aspect of the present invention, there is provided a character input method for a terminal to input characters, the character input method including: a step of allocating, to a touch screen, a separate touch area for inputting characters; and a step of displaying characters in surroundings or around the circumference of the allocated touch area, and displaying the characters in different locations.

In accordance with another aspect of the present invention, there is provided a computer-readable recording medium that records a program for implementing a character input method, the computer-readable recording medium that records a program implementing: a function of allocating, to a touch screen, a separate touch area for inputting characters; and a function of displaying characters in surroundings or around the circumference of the allocated touch area, and displaying the characters in different locations.

As described above, according to the present invention, there is provided a character input technology for a user to input characters without viewing a screen.

Also, according to the present invention, there is provided a character input technology for maximally reducing a probability of a typographic error while characters are input.

### BRIEF DESCRIPTION OF THE DRAWINGS

FIG. 1 is a block diagram of a terminal that inputs characters according to an embodiment of the present invention;

FIG. 2 illustrates a character input screen including one character input area;

FIG. 3 illustrates a table in which the alphabet is matched to sliding touch patterns, for inputting English;

FIG. 4 illustrates a sliding touch scheme of a user for inputting an English word;

FIG. 5 illustrates a character input screen that further displays, around the circumference of a character input area, a plurality of touch guide indicators where the alphabet is displayed;

FIG. 6 illustrates a table in which consonants and vowels are matched to sliding touch patterns, for inputting Hangul;

FIG. 7 illustrates a method of inputting a Hangul word in a character input screen;

FIG. 8 illustrates a character input screen that further displays, around the circumference of a character input area, a plurality of touch guide indicators where consonants and vowels are displayed;

FIG. 9 illustrates a character input screen including two character input areas;

FIG. 10 illustrates a character input screen that further displays, around the circumference of each of the two character input areas, a plurality of touch guide indicators where consonants and vowels are displayed;

FIG. 11 illustrates a method of inputting a Hangul word in a character input screen including two character input areas;

FIG. 12 illustrates a table in which consonants are matched to sliding touch patterns and a table in which vowels are matched to sliding touch patterns, when the two character input areas are a consonant input area and a vowel input area;

FIG. 13 illustrates a method of inputting a Hangul word, when the two character input areas are a consonant input area and a vowel input area;

FIG. 14 illustrates a character input screen that further displays, around the circumference of a character input area corresponding to a consonant input area, a plurality of touch guide indicators where consonants are displayed, and displays, around the circumference of a character input area corresponding to a vowel input area, a plurality of touch guide indicators where vowels are displayed;

FIG. 15 is a diagram illustrating a function executed when a touch excluding a sliding touch is generated in a character input area or when a touch is generated outside the character input area;

FIG. 16 is a flowchart of a character input method according to an embodiment of the present invention;

FIG. 17 is a block diagram of a terminal that inputs characters according to another embodiment of the present invention;

FIG. 18 is a block diagram of a terminal that inputs characters according to another embodiment of the present invention;

FIG. 19 is a block diagram of a terminal that inputs characters according to another embodiment of the present invention; and

FIG. 20 is a flowchart of a character input method according to another embodiment of the present invention.

### MODE FOR CARRYING OUT THE INVENTION

Hereinafter, a few embodiments of the present invention will be described with reference to the accompanying drawings. In the following description, the same components will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

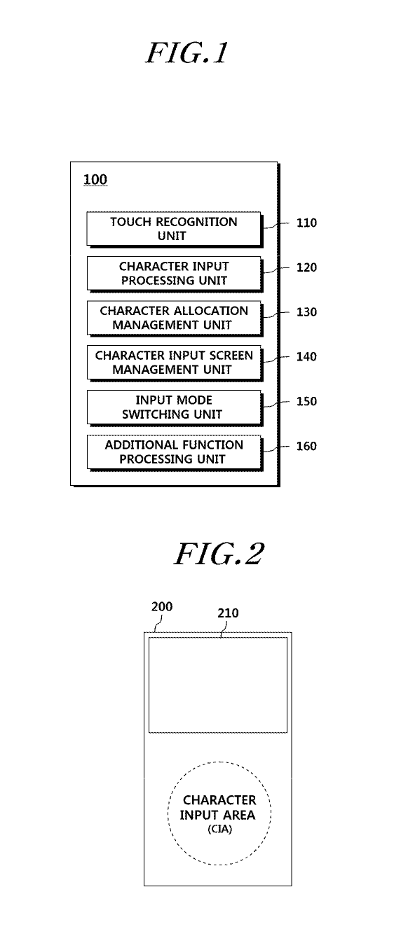

FIG. 1 is a block diagram of a terminal 100 that inputs characters according to an embodiment of the present invention.

Referring to FIG. 1, the terminal 100 that inputs characters according to an embodiment of the present invention includes a touch recognition unit 110 that recognizes one or more pieces of information from among original orientation information and reorientation number information for a sliding touch of a user on a touch screen, a character input processing unit 120 that determines, to be an input character, a character allocated to correspond to one or more pieces of information from among the original orientation information and reorientation number information for the sliding touch recognized by the touch recognition unit 110, and processes inputting, and the like.

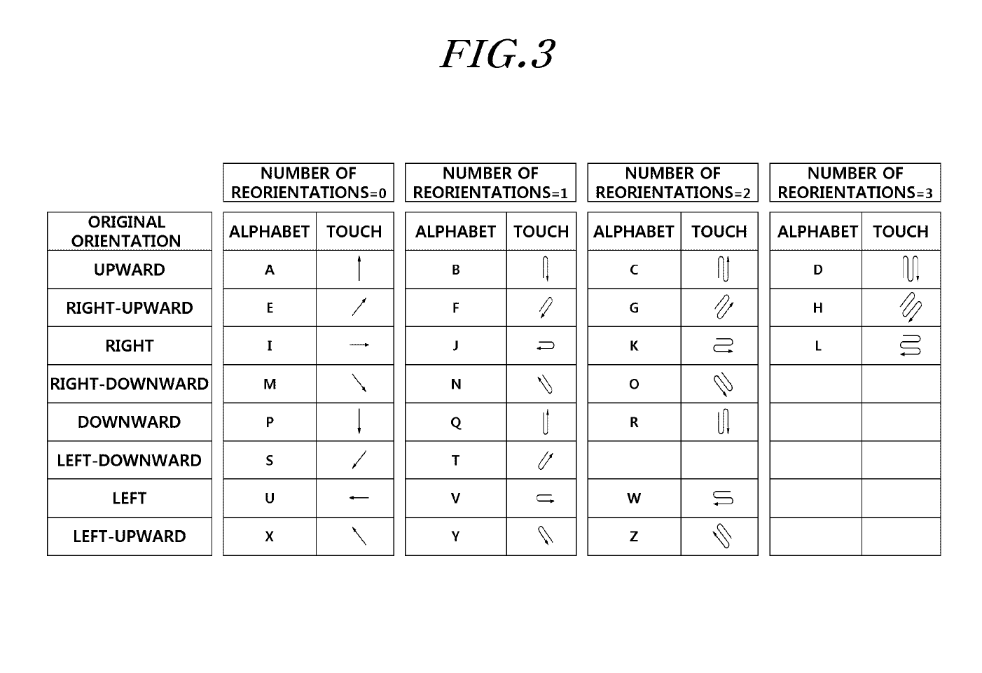

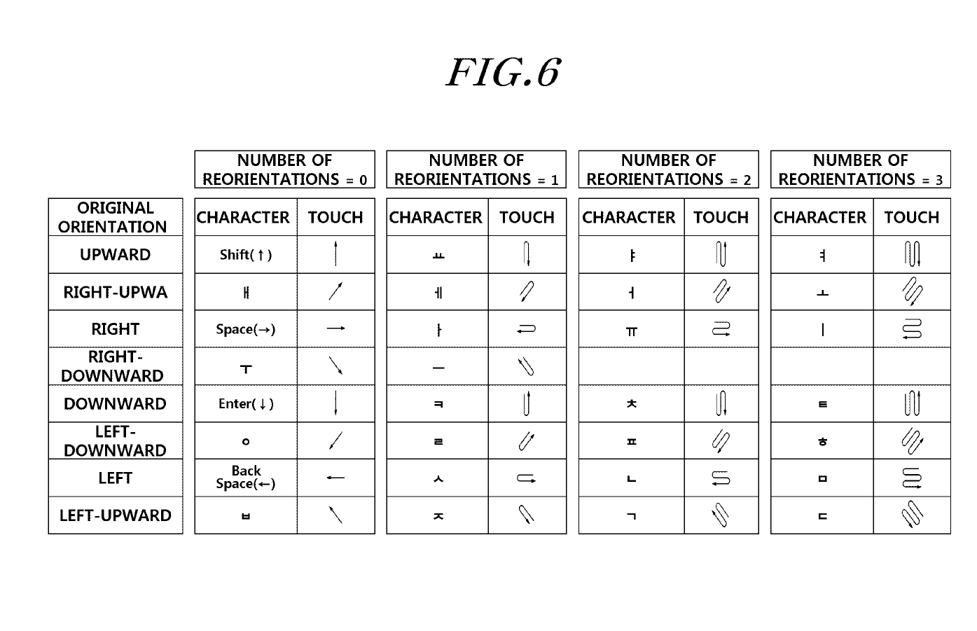

The terminal 100 for inputting characters according to an embodiment of the present invention further includes a character allocation management unit 130 that matches, to each character, original orientation information and reorientation number information for a sliding touch required for inputting a corresponding character, and stores and manages the same as a table. The table is illustrated in FIG. 3, FIG. 6, FIG. 12, and the like.

That is, the table stored and managed by the character allocation management unit 130 defines a sliding touch pattern (an original orientation and a number of reorientations) for each character.

For example, referring to the table of FIG. 3, the alphabet letter “A” is matched to an original orientation of an upward ( [symbol] ) direction and 0 reorientation. Therefore, to input “A”, there is a need for a sliding touch that slides (dragging) in an upward direction and ends. The alphabet letter “B” is matched to an original orientation of an upward ( [symbol] ) direction and 1 reorientation. Therefore, to input “B”, there is a need for a sliding touch that slides in an upward direction, slides in a downward direction through reorientation one time, and ends.

In the table that is stored and managed by the character allocation management unit 130, one or more pieces of information from among original orientation information and reorientation number information matched to a character is different from one or more pieces of information from among original orientation information and reorientation number information matched to another character.

For example, referring to the table of FIG. 3, like the alphabet letters “A” and “B”, the original orientation may be identical but the number of reorientations may be different from each other, and like the alphabet letters “A” and “F”, both the original orientation and the number of reorientations may be different from each other.

When a sliding touch of a user is recognized through the touch screen, the character input processing unit 120 as described above refers to the table that is stored and managed by the character allocation management unit 130 so as to determine an input character for a sliding touch pattern (original orientation information and reorientation number information) associated with the recognized sliding touch.

As illustrated in FIG. 1, the terminal 100 that inputs characters according to an embodiment of the present invention may further include a character input screen management unit 140 that displays a character input screen on the touch screen.

The character input screen management unit 140 may allocate a character input area (CIA: Character Input Area) to a character input screen of the touch screen, as a separate touch area for a sliding touch of a user, and displays the same to be recognized.

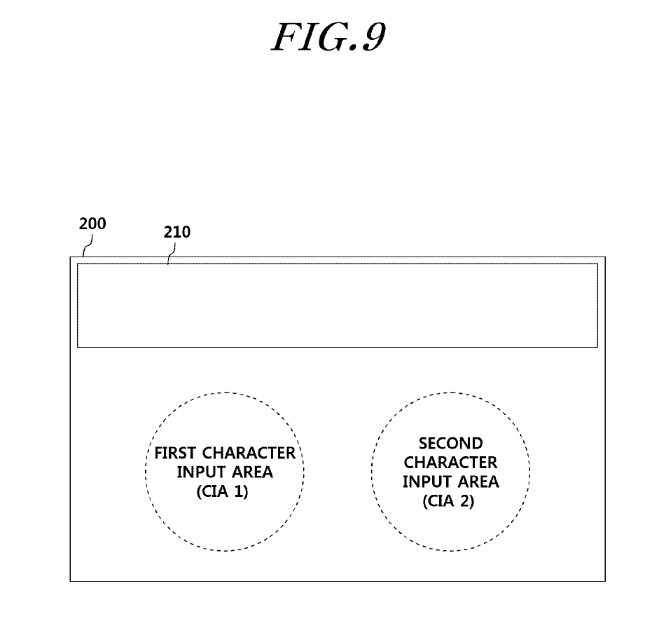

A single character input area may be allocated and displayed on the character input screen 200 as illustrated in FIG. 2, or a plurality of character input areas may be allocated and displayed on the character input screen 200 as illustrated in FIG. 9.

Also, the character input screen management unit 140 may display, in surroundings or around the circumference of the character input area, a plurality of touch guide indicators for guiding about original orientation information and reorientation number information for a sliding touch of a user.

Also, the character input screen management unit 140 may display the plurality of touch guide indicators to be located in different directions from the center of the character input area when displaying the plurality of touch guide indicators.

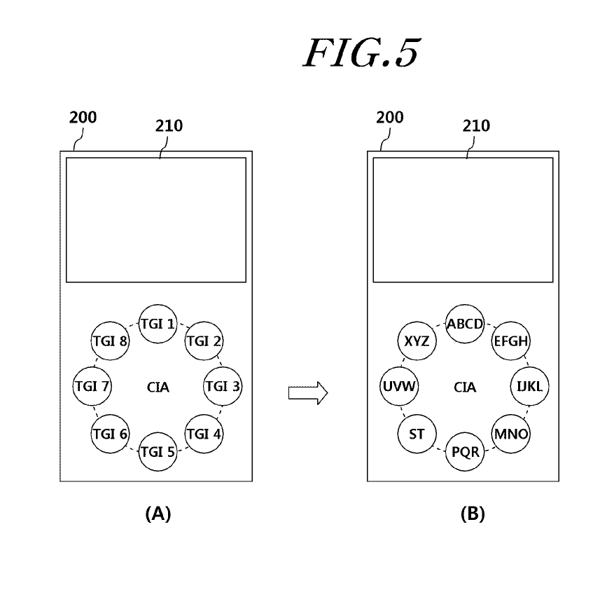

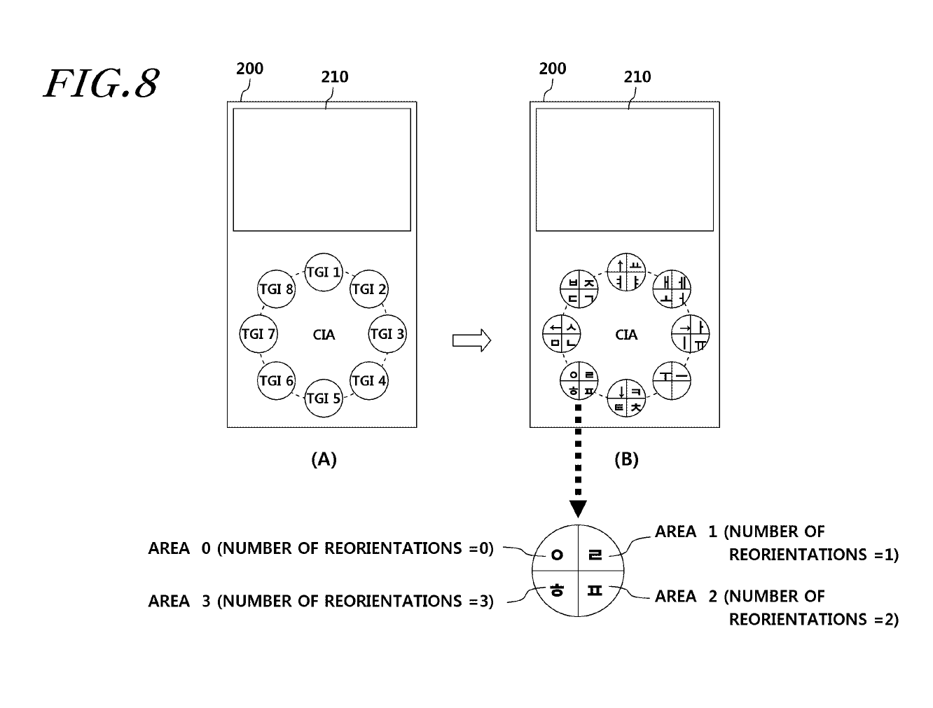

For example, referring to FIG. 5 (a) and FIG. 8 (a) that illustrate the character input screen 200 when a single Character Input Area (CIA) is used, 8 touch guide indicators (TGI 1, TGI 2, TGI 3, TGI 4, TGI 5, TGI 6, TGI 7, and TGI 8) are located in different directions from the center of the Character Input Area (CIA).

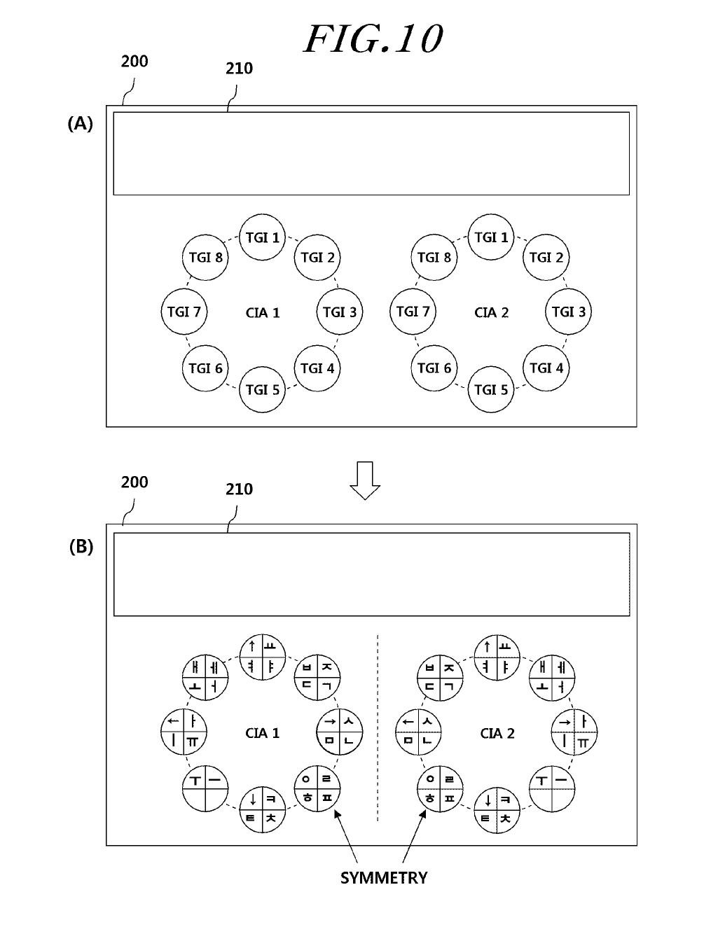

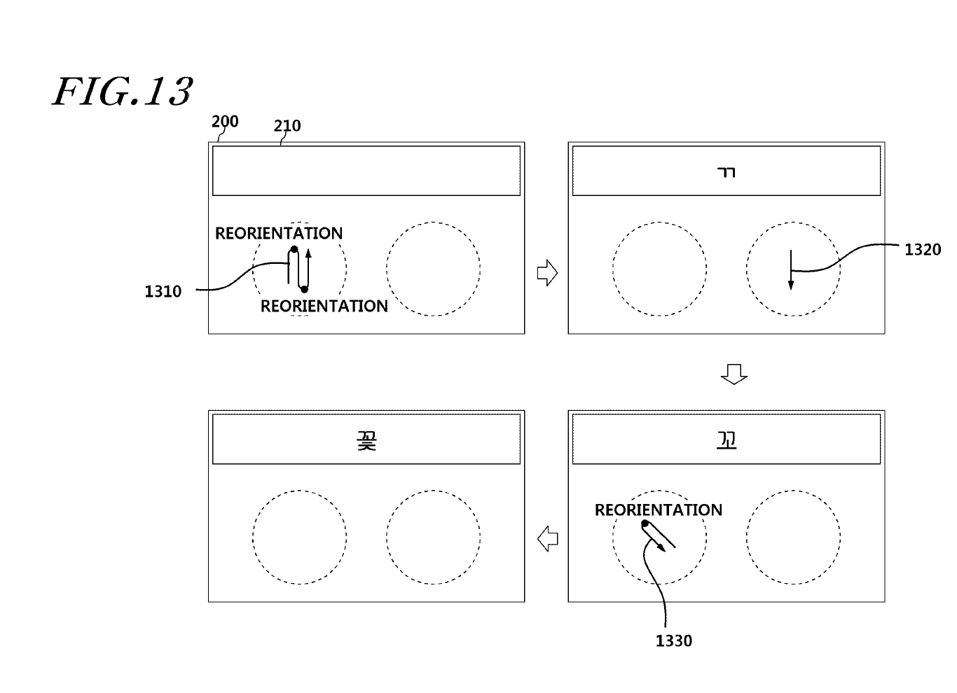

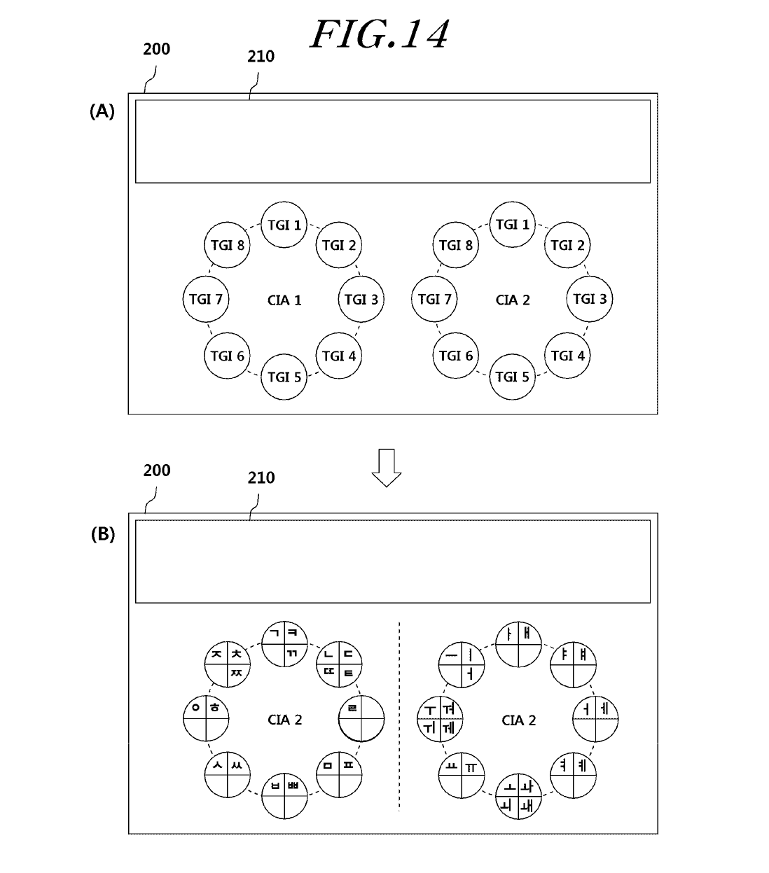

Also, referring to FIG. 10 (a) and FIG. 14 (a) that illustrate the character input screen 200 when two character input areas (CIA) are used, 8 touch guide indicators (TGI 1, TGI 2, TGI 3, TGI 4, TGI 5, TGI 6, TGI 7, and TGI 8) are located in different locations for each character input area.

In examples of FIG. 5 (a), FIG. 8 (a), FIG. 10 (a), and FIG. 14 (a), TGI 1 is located in the upper portion ( [symbol] ) from the center of the character input area (CIA, CIA 1, or CIA 2), TGI 2 is located in the upper right portion ( [symbol] ) from the center of the character input area (CIA, CIA 1 or CIA 2), and TGI 3 is located in the right ( [symbol] ) portion from the center of the character input area (CIA, CIA 1, or CIA 2), TGI 4 is located in the lower-right portion ( [symbol] ) from the center of the character input area (CIA, CIA 1, or CIA 2), TGI 5 is located in the lower portion ( [symbol] ) from the center of the character input area (CIA, CIA 1, or CIA 2), TGI 6 is located in the lower-left portion ( [symbol] ) from the center of the character input area (CIA, CIA 1, or CIA 2), TGI 7 is located in the left ( [symbol] ) portion from the center of the character input area (CIA, CIA 1, or CIA 2), and TGI 8 is located in the upper-left portion ( [symbol] ) from the center of the Character Input Area (CIA).

Also, the character input screen management unit 140 may display a character in each of the plurality of touch guide indicators located in different directions from the center of the character input area.

A single character or a plurality of characters may be displayed in each of the plurality of touch guide indicators.

A scheme of displaying a character in each of the plurality of touch guide indicators may be, as shown in FIG. 5 (b), a character listing scheme. For example, referring to FIG. 5 (b), when 4 characters (A, B, C, and D) are displayed in TGI 1, 4 characters may be listed as “ABCD”.

Here, a sequence of listing the characters may be determined based on a number of reorientations. For example, referring to FIG. 5 (b), with “ABCD” displayed in TGI 1 based on the character listing scheme, A has 0 reorientations, B has 1 reorientation, C has 2 reorientations, and D has 3 reorientations.

A scheme of displaying a character in each of the plurality of touch guide indicators may be an area division displaying scheme that divides a touch guide indicator into a plurality of areas and displays a character in each of the divided areas, as shown in FIG. 8 (b), FIG. 10 (b), and FIG. 14 (b).

For example, referring to FIG. 8 (b) that illustrates the character input screen 200 when a single Character Input Area (CIA) is used, when a corresponding character(s) is displayed in each of the 8 touch guide indicators (TGI 1, TGI 2, TGI 3, TGI 4, TGI 5, TGI 6, TGI 7, and TGI 8), each touch guide indicator is divided into 4 areas and the corresponding character is displayed in each divided area.

Here, a number of divided areas may be different based on a number of characters to be displayed.

Also, each divided area corresponds to reorientation number information. For example, referring to FIG. 8 (b), from among 4 areas obtained by dividing TGI 5, an area where “ [symbol] ” is displayed corresponds to 0 reorientation, an area where “ [symbol] ” is displayed corresponds to 1 reorientation, an area where “ [symbol] ” displayed corresponds to 2 reorientations, and an area where “ [symbol] ” is displayed corresponds to 3 reorientations.

As described above, in a state in which a table including sliding touch pattern information (original orientation information and reorientation number information) for each character is stored, when one or more pieces of information from among original orientation information and reorientation number information associated with a sliding touch of a user generated through a touch screen is recognized, the character input processing unit 120 searches the table for a character corresponding to one or more pieces of recognized information from among the original orientation information and the reorientation number information, determines the retrieved character to be an input character, and processes character inputting.

The character input processing unit 120 may use only the original orientation information associated with a sliding touch, to determine an input character. This corresponds to a case in which only a single character is displayed in a single touch guide indicator.

In this example, the character input processing unit 120 determines a predetermined touch guide indicator located in a direction corresponding to the original orientation information associated with the sliding touch recognized in the character input area from among a plurality of touch guide indicators, determines a character displayed in the determined predetermined touch guide indicator to be the input character, and processes inputting.

Also, the character input processing unit 120 may use both original orientation information and reorientation number information associated with a sliding touch, to determine an input character. This corresponds to a case in which a plurality of characters is displayed in a single touch guide indicator.

In this case, the character input processing unit 120 determines a predetermined touch guide indicator located in a direction corresponding to the original orientation information associated with the sliding touch recognized in the character input area, from among the plurality of touch guide indicators, and when a plurality of characters are displayed in the determined predetermined touch guide indicator, determines, to be the input character from among the plurality of characters, a character corresponding to the reorientation number information associated with the sliding touch recognized in the character input area, and processes inputting.

As described above, a plurality of character input areas are allocated to the touch screen, and may be displayed on the character input screen. That is, the character input screen management unit 140, as illustrated in FIG. 9 and FIG. 10, may allocate a plurality of character input areas to the touch screen and may display the same to be recognized. In this case, the character input screen management unit 140, as illustrated in FIG. 10, may display a plurality of touch guide indicators in surroundings or around the circumference of each of the plurality of character input areas.

When a plurality of character input areas exist, a scheme of displaying a character in the plurality of touch guide indicators may correspond to a symmetrical character displaying scheme or an asymmetrical character displaying scheme.

When providing the symmetric character displaying scheme, as illustrated in FIG. 10, the character input screen management unit 140 may display identical characters, in a symmetrical manner, in a plurality of touch guide indicators displayed in surroundings or around the circumference of a first character input area (CIA 1) from among the plurality of character input areas and in a plurality of touch guide indicators displayed in surroundings or around the circumference of a second character input area (CIA 2) from among the plurality of character input areas.

When providing the asymmetric character displaying scheme, as illustrated in FIG. 14, the character input screen management unit 140 may display characters (for example: consonants) of a first character group (for example: a consonant group) in a plurality of touch guide indicators displayed in surroundings or around the circumference of the first character input area (CIA 1) from among the plurality of character input areas, and displays characters (for example: vowels) of a second character group (for example: a vowel group), which is different from the first character group, in a plurality of touch guide indicators displayed in surroundings or around the circumference of the second character input area (CIA 2) from among the plurality of character input areas.

As illustrated in FIG. 1, the terminal 100 that inputs characters according to an embodiment of the present invention may further include an input mode switching unit 150 that switches a type of an input character when a touch generated in the character input area is recognized by the touch recognition unit 110 to be different from a sliding touch or when a touch generated outside the character input area is recognized.

As illustrated in FIG. 1, the terminal 100 that inputs characters according to an embodiment of the present invention may further include a additional function processing unit 160 that processes one or more functions from among a character erasing function (a back space function), a spacing function (a space function), a line changing function (a enter function), and a shift key (Shift Key) function, when a touch generated in the character input area is recognized by the touch recognition unit 110 to be different from a sliding touch or when a touch generated outside the character input area is recognized.

As described above, the additional function (character erasing function, a spacing function, a line changing function, a shift key function, and the like) may be implemented by a touch that is generated in the character input area and of which a type is different from a sliding touch or a touch generated outside the character input area, or may be implemented by allocating a corresponding additional function to the plurality of touch guide indicators.

To this end, the character input screen management unit 140 may display a function key (Function Key) in one or more touch guide indicators from among the plurality of touch guide indicators. Here, the function key is a key that is different from a key for inputting a character that is visible to the naked eyes, and includes a shift key, a back space key, a space key, an enter key, and the like.

As an example, the additional function processing unit 160 allocates a shift key (Shift Key, ↑) to a touch guide indicator displayed in the upper portion ( [symbol] ) from the center of the character input area and executes a shift key (Shift Key) function when an original orientation sliding touch is recognized to be an upward ( [symbol] ) direction, allocates an enter key (Enter key, ↓) to a touch guide indicator displayed in the lower portion ( [symbol] ) from the center of the character input area and executes an enter key (Enter Key) function when the original orientation for the sliding touch is recognized to be a downward direction ( [symbol] ), allocates a back space key (Backspace Key, ←) in a touch guide indicator displayed in the left ( [symbol] ) portion from the center of the character input area and executes a backspace key (Backspace Key) function when the original orientation for the sliding touch is recognized to be the left ( [symbol] ) direction, and allocates a space key (Space Key, →) to a touch guide displayed in the right ( [symbol] ) portion from the center of the character input area and executes a space key (Space Key) function when the original orientation for the sliding touch is recognized to be the right ( [symbol] ) direction.

Hereinafter, the character input method as described above will be illustrated with reference to FIGS. 2 through 15.

FIG. 2 illustrates the character input screen 200 including 1 Character Input Area (CIA).

Referring to FIG. 2, on the character input screen 200 that is output on a touch screen, a Character Input Area (CIA) that is a separate touch area through which a character is input is allocated. An area may be displayed so that the Character Input Area (CIA) may be recognized by a user.

As illustrated in FIG. 2, on the character input screen 200, a display area 210 displaying a character for which an inputting process is completed may be allocated and displayed.

Hereinafter, a character input method associated with an English input mode will be described with reference to FIGS. 3 through 5, based on the character input screen 200 of FIG. 2.

FIG. 3 illustrates a table in which the alphabet is matched to sliding touch patterns, for inputting English.

As illustrated in FIG. 3, in the table, original orientation information and reorientation number information are matched to a sliding touch defined for each character and stored.

For example, A is matched to original orientation information of an “upward ( [symbol] ) direction” and reorientation number information of “0”. B is matched to original orientation information of an “upward ( [symbol] ) direction” and reorientation number information of “1”. C is matched to original orientation information of an “upward ( [symbol] ) direction” and reorientation number information of “2”. D is matched to original orientation information of an “upward ( [symbol] ) direction” and reorientation number information of “3”.

In the table of FIG. 3, an arrow displayed in a touch field may not need to be stored in the table, but a sliding touch motion of a user based on original orientation information and a number of reorientations is schematically illustrated in the form of an arrow.

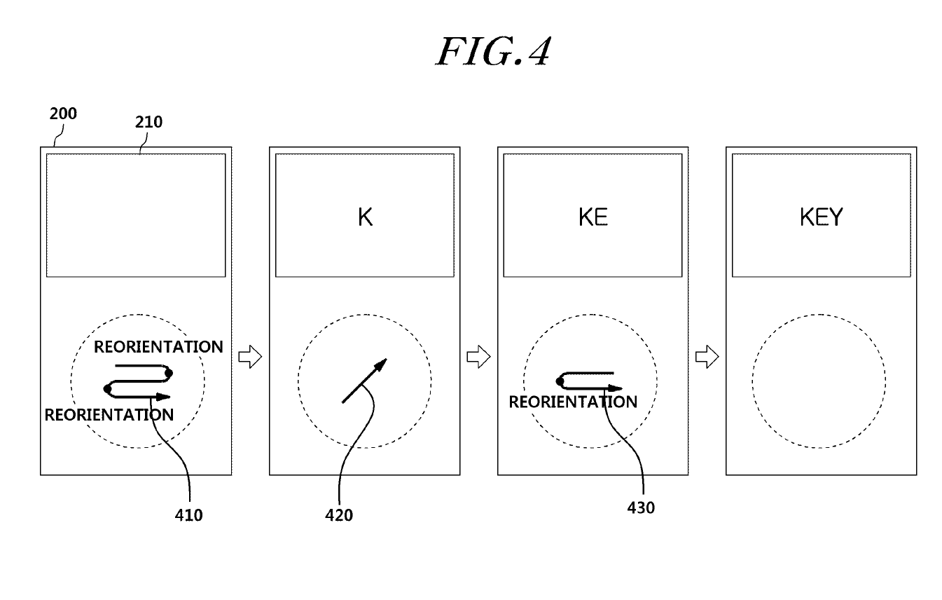

FIG. 4 illustrates a sliding touch scheme of a user for inputting an English word.

FIG. 4 is a diagram illustrating a scheme in which a user provides a touch in a Character Input Area (CIA), so as to input an English word “KEY”.

First, as original orientation information is defined to be the right ( [symbol] ) direction and reorientation number information is defined to be 2 for K in the table of FIG. 3, a sliding touch 410 may be provided in a manner that initially slides to the right by touching the Character Input Area (CIA), slides by executing 2 reorientations in a state of maintaining the touch, and finishes the touch, so as to input “K”.

Subsequently, as original orientation information is defined to be the right-upward ( [symbol] ) direction and reorientation number information is defined to be 0 for E in the table of FIG. 3, a sliding touch 420 may be provided in a manner that slides to the right-upward direction by touching the Character Input Area (CIA), and finishes the touch without reorientation, so as to input “E”.

Finally, as original orientation information is defined to be a left-upward ( [symbol] ) direction and reorientation number information is defined to be 1 for Y in the table of FIG. 3, a sliding touch 430 may be provided in a manner that initially slides to a left-upward direction by touching the Character Input Area (CIA), slides by executing 1 reorientation in a state of maintaining the touch, and finishes the touch, so as to input “Y”.

When a user memorizes sliding touch pattern information (original orientation information and reorientation number information) matched to each character in the table of FIG. 3, for inputting a desired character, the user may input characters without viewing the character input screen 200.

To intuitively inform a user of sliding touch pattern information (original orientation information and reorientation number information) matched to each character in the table of FIG. 3, a plurality of touch guide indicators (TGI) may be further displayed in surroundings or around the circumference of the Character Input Area (CIA).

FIG. 5 illustrates the character input screen 200 that further displays, in around the circumference of a Character Input Area (CIA), a plurality of touch guide indicators (TGI) where the alphabet is displayed.

Referring to FIG. 5 (a), the character input screen management unit 140 displays 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the Character Input Area (CIA).

Referring to FIG. 5 (b), the character input screen management unit 140 displays a character in each of the 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the Character Input Area (CIA).

TGI 1 is located in the upper portion of the Character Input Area (CIA) and thus, referring to the table of FIGS. 3, A, B, C, and D of which original orientation information correspond to an upward direction may be displayed in TGI 1. In this example, a character of which reorientation number information is lower is displayed earlier in TGI 1. That is, “ABCD” is displayed in TGI 1.

TGI 2 is located in the upper-right portion from the center the Character Input Area (CIA) and thus, referring to the table of FIGS. 3, E, F, G and H of which original orientation information correspond to a right-upward direction may be displayed in TGI 2. In this example, a character of which reorientation number information is lower is displayed earlier in TGI 2. That is, “EFGH” is displayed in TGI 2.

TGI 3 is located in the right portion from the center of the Character Input Area (CIA) and thus, referring to the table of FIGS. 3, I, J, K, and L of which original orientation information correspond to the right direction may be displayed in TGI 3. In this example, a character of which reorientation number information is lower is displayed earlier in TGI 3. That is, “IJKL” is displayed in TGI 3.

TGI 4 is located in the lower-right portion from the center of the Character Input Area (CIA) and thus, referring to the table of FIGS. 3, M, N, and O of which original orientation information correspond to a right-downward direction may be displayed in TGI 4. In this example, a character of which reorientation number information is lower is displayed earlier in TGI 4. That is, “MNO” is displayed in TGI 4.

TGI 5 is located in the lower portion from the center of the Character Input Area (CIA) and thus, referring to the table of FIGS. 3, P, Q, and R of which original orientation information correspond to a downward direction may be displayed in TGI 5. In this example, a character of which reorientation number information is lower is displayed earlier in TGI 5. That is, “PQR” is displayed in TGI 5.

TGI 6 is located in the lower-left portion from the center of the Character Input Area (CIA) and thus, referring to the table of FIGS. 3, S and T of which original orientation information correspond to a left-downward direction may be displayed in TGI 6. In this example, a character of which reorientation number information is lower is displayed earlier in TGI 6. That is, “ST” is displayed in TGI 6.

TGI 7 is located in the left portion from the center of the Character Input Area (CIA) and thus, referring to the table of FIGS. 3, U, V, and W of which original orientation information correspond to the left direction may be displayed in TGI 7. In this example, a character of which reorientation number information is lower is displayed earlier in TGI 7. That is, “UVW” is displayed in TGI 7.

TGI 8 is located in the upper-left portion from the center of of the Character Input Area (CIA) and thus, referring to the table of FIGS. 3, X, Y, and Z of which original orientation information correspond to a left-upward direction may be displayed in TGI 8. In this example, a character of which reorientation number information is lower is displayed earlier in TGI 8. That is, “XYZ” is displayed in TGI 8.

Hereinafter, a character input method associated with a Hangul input mode will be described with reference to FIGS. 6 through 8, based on the character input screen 200 of FIG. 2.

FIG. 6 illustrates a table in which consonants and vowels are matched to sliding touch patterns, for inputting Hangul.

As illustrated in FIG. 6, in the table, original orientation information and reorientation number information are matched to a sliding touch defined for each consonant and each vowel, and stored.

For example, a consonant “ [symbol] ” is matched to original orientation information of a “left-upward ( [symbol] ) direction” and reorientation number information of “0”. A consonant “ [symbol] ” is matched to original orientation information of a “left-upward ( [symbol] ) direction” and reorientation number information of “1”. A consonant “ [symbol] ” is matched to original orientation information of a “left-upward ( [symbol] ) direction” and reorientation number information of “2”. A consonant “ [symbol] ” is matched to original orientation information of a “left-upward ( [symbol] ) direction” and reorientation number information of “3”.

Also, a vowel “ [symbol] ” is matched to original orientation information of a “right-upward ( [symbol] ) direction” and reorientation number information of “0”. A vowel “ [symbol] ” is matched to original orientation information of a “right-upward ( [symbol] ) direction” and reorientation number information of “1”. A vowel “ [symbol] ” is matched to original orientation information of a “right-upward ( [symbol] ) direction” and reorientation number information of “2”. A vowel “ [symbol] ” is matched to original orientation information of a “right-upward ( [symbol] ) direction” and reorientation number information of “3”.

Meanwhile, in the table of FIG. 6, original orientation information and reorientation number information for a sliding touch are defined and matched to a function key including a shift key (Shift, ↑), a space key (Space, →), an enter key (Enter, ↓) and a backspace key (Backspace, ←), in addition to the consonants and vowels.

Here, for each function key, original orientation information is defined to be appropriate for each function.

For example, the original orientation information of the shift key (Shift, ↑) is defined to be an upward direction to be appropriate for the function, the original orientation information of the space key (Space, →) is defined to be the right direction to be appropriate for the function, the original orientation information of the enter key (Enter, ↓) is defined to be a downward direction to be appropriate for the function, and the original orientation information of the backspace key (Backspace, ←) is defined to be the left direction to be appropriate for the function.

In the table of FIG. 6, an arrow displayed in a touch field may not need to be stored in the table, but a sliding touch motion of a user based on original orientation information and a number of reorientations is schematically illustrated in a form of an arrow.

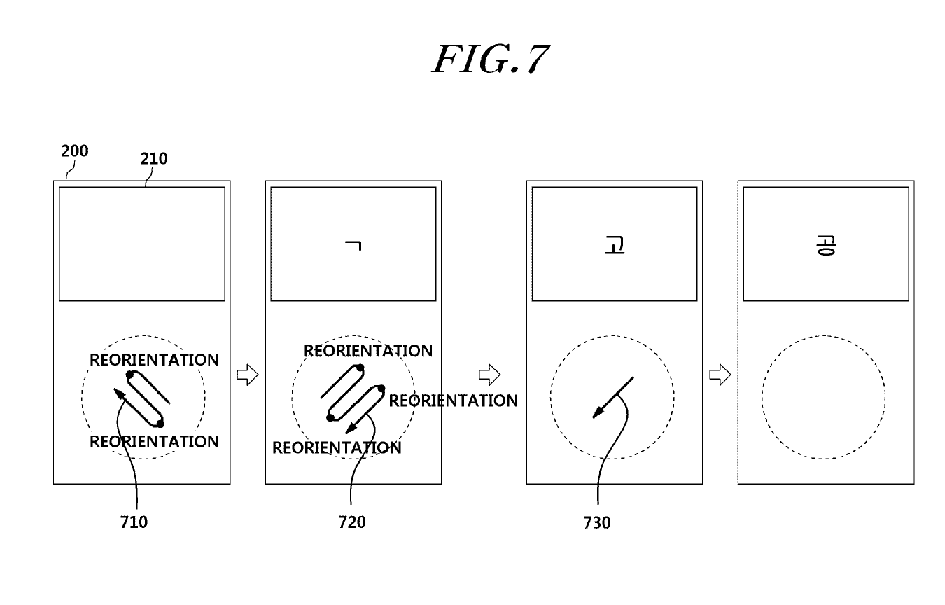

FIG. 7 illustrates a method of inputting a Hangul word in a character input screen.

FIG. 7 is a diagram illustrating a scheme in which a user provides a touch in a Character Input Area (CIA), so as to input a Hangul word “ [symbol] ”.

First, as original orientation information is defined to be a left-upward direction and reorientation number information is defined to be 2 for “ [symbol] ” in the table of FIG. 6, a sliding touch 710 may be provided in a manner that initially slides to a left-upward direction by touching the Character Input Area (CIA), slides by executing 2 reorientations in a state of maintaining the touch, and finishes the touch, so as to input a consonant “ [symbol] ”.

Subsequently, as original orientation information is defined to be the right-upward ( [symbol] ) direction and “ [symbol] ” reorientation number information is defined to be 3 for provided in a manner that initially slides to the right-upward direction by touching the Character Input Area (CIA), slides by executing 3 reorientations in a state of maintaining the touch, and finishes the touch, so as to input a vowel “ [symbol] ”.

Finally, as original orientation information is defined to be a left-downward direction and reorientation number information is defined to be 0 for “ [symbol] ” in the table of FIG. 6, a sliding touch 730 may be provided in a manner that slides to a left-downward direction by touching the Character Input Area (CIA), and finishes the touch without reorientation, so as to input a consonant “ [symbol] ”.

When a user memorizes sliding touch pattern information (original orientation information and reorientation number information) matched to each consonant and vowel in the table of FIG. 6, for inputting a desired character, the user may input characters without viewing the character input screen 200.

To intuitively inform a user of sliding touch pattern information (original orientation information and reorientation number information) matched to each consonant and vowel in the table of FIG. 6, a plurality of touch guide indicators (TGI) may be further displayed in surroundings or around the circumference of the Character Input Area (CIA).

FIG. 8 illustrates the character input screen 200 that further displays, around the circumference of a Character Input Area (CIA), a plurality of touch guide indicators (TGI) where consonants and vowels are displayed.

Referring to FIG. 8 (a), the character input screen management unit 140 displays 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, and upper-left) from the center of the Character Input Area (CIA).

Referring to FIG. 8 (b), the character input screen management unit 140 displays characters (consonants or vowels) and 4 function keys (↑, ↓, →, ←) in each of the 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, and upper-left) from the center of the Character Input Area (CIA).

TGI 1 is located in the upper portion from the center of the Character Input Area (CIA) and thus, referring to the table of FIG. 6, “a shift key (Shift, ↑), [symbol] , [symbol] , [symbol] ” of which original orientation information corresponds to an upward direction may be displayed in TGI 1. In this example, TGI 1 is divided into 4 areas (area 0, area 1, area 2, and area 3), and characters are sequentially displayed in area 0, area 1, and area 2, area 3, in order of lowest reorientation number information. That is, in TGI 1, “the shift key (Shift, ↑)” is displayed in area 0 (an area where a number of reorientations corresponds to 0), “ [symbol] ” is displayed in area 1 (an area where a number of reorientations corresponds to 1), “ [symbol] ” is displayed in area 2 (an area where a number of reorientations corresponds to 2), and “ [symbol] ” is displayed in area 3 (an area where a number of reorientations corresponds to 3).

TGI 2 is located in the upper-right portion from the center of the Character Input Area (CIA) and thus, referring to the table of FIG. 6, “ [symbol] , [symbol] , [symbol] , and [symbol] ” of which original orientation information corresponds to a right-upward direction may be displayed in TGI 2. In this example, TGI 2 is divided into 4 areas (area 0, area 1, area 2, and area 3), and characters are sequentially displayed in area 0, area 1, and area 2, area 3, in order of lowest reorientation number information. That is, in TGI 2, “ [symbol] ” is displayed in area 0 (an area where a number of reorientations corresponds to 0), “ [symbol] ” is displayed in area 1 (an area where a number of reorientations corresponds to 1), “ [symbol] ” is displayed in area 2 (an area where a number of reorientations corresponds to 2), and “ [symbol] ” is displayed in area 3 (an area where a number of reorientations corresponds to 3).

TGI 3 is located in the right portion from the center of the Character Input Area (CIA) and thus, referring to the table of FIG. 6, “the space key (Space, →), [symbol] , [symbol] , [symbol] ” of which original orientation information correspond to the right direction may be displayed in TGI 3. In this example, TGI 3 is divided into 4 areas (area 0, area 1, area 2, and area 3), and characters are sequentially displayed in area 0, area 1, and area 2, area 3, in order of lowest reorientation number information. That is, in TGI 3, “the space key (Space, ↑)” is displayed in area 0 (an area where a number of reorientations corresponds to 0), “ [symbol] ” is displayed in area 1 (an area where a number of reorientations corresponds to 1), “ [symbol] ” is displayed in area 2 (an area where a number of reorientations corresponds to 2), and “ [symbol] ” is displayed in area 3 (an area where a number of reorientations corresponds to 3).

TGI 4 is located in the lower-right portion from the center of the Character Input Area (CIA) and thus, referring to the table of FIG. 6, “ [symbol] ” and “ [symbol] ” which original orientation information correspond to a right-downward direction may be displayed in TGI 4. In this example, TGI 4 is divided into 4 areas (area 0, area 1, area 2, and area 3), and characters are sequentially displayed in area 0, area 1, and area 2, area 3, in order of lowest reorientation number information. That is, in TGI 4, “ [symbol] ” is displayed in area 0 (an area where a number of reorientations corresponds to 0), and “ [symbol] ” is displayed in area 2 (an area where a number of reorientations corresponds to 2).

TGI 5 is located in the lower portion from the center of the Character Input Area (CIA) and thus, referring to the table of FIG. 6, “the enter key (Enter, ↓), [symbol] , [symbol] , and [symbol] ” of which original orientation information correspond to a downward direction may be displayed in TGI 5. In this example, TGI 5 is divided into 4 areas (area 0, area 1, area 2, and area 3), and characters are sequentially displayed in area 0, area 1, and area 2, area 3, in order of lowest reorientation number information. That is, in TGI 5, “the enter key (Enter, ↓)” is displayed in area 0 (an area where a number of reorientations corresponds to 0), “ [symbol] ” is displayed in area 1 (an area where a number of reorientations corresponds to 1), “ [symbol] ” is displayed in area 2 (an area where a number of reorientations corresponds to 2), and “ [symbol] ” is displayed in area 3 (an area where a number of reorientations corresponds to 3).

TGI 6 is located in the lower-left portion from the center of the Character Input Area (CIA) and thus, referring to the table of FIG. 6, “ [symbol] [symbol] , [symbol] , and [symbol] ” of which original orientation information corresponds to a left-downward direction may be displayed in TGI 6. In this example, TGI 6 is divided into 4 areas (area 0, area 1, area 2, and area 3), and characters are sequentially displayed in area 0, area 1, and area 2, area 3, in order of lowest reorientation number information. That is, in TGI 6, “ [symbol] ” is displayed in area 0 (an area where a number of reorientations corresponds to 0), “ [symbol] ” is displayed in area 1 (an area where a number of reorientations corresponds to 1), “ [symbol] ” is displayed in area 2 (an area where a number of reorientations corresponds to 2), and “ [symbol] ” played in area 3 (an area where a number of reorientations corresponds to 3).

TGI 7 is located in the left portion from the center of the Character Input Area (CIA) and thus, referring to the table of FIG. 6, “the backspace key (Backspace, ←), [symbol] , [symbol] , and [symbol] ” of which original orientation information correspond to the left direction may be displayed in TGI 7. In this example, TGI 7 is divided into 4 areas (area 0, area 1, area 2, and area 3), and characters are sequentially displayed in area 0, area 1, and area 2, area 3, in order of lowest reorientation number information. That is, in TGI 7, “the backspace key (Backspace, ←)” is displayed in area 0 (an area where a number of reorientations corresponds to 0), “ [symbol] ” is displayed in area 1 (an area where a number of reorientations corresponds to 1), “ [symbol] ” is displayed in area 2 (an area where a number of reorientations corresponds to 2), and “ [symbol] ” is displayed in area 3 (an area where a number of reorientations corresponds to 3).

TGI 8 is located in the upper-left portion from the center of the Character Input Area (CIA) and thus, referring to the table of FIG. 6, “ [symbol] , [symbol] , [symbol] , and [symbol] ” of which original orientation information correspond to a left-upward direction may be displayed in TGI 8. In this example, TGI 8 is divided into 4 areas (area 0, area 1, area 2, and area 3), and characters are sequentially displayed in area 0, area 1, and area 2, area 3, in order of lowest reorientation number information. That is, in TGI 8, “ [symbol] ” is displayed in area 0 (an area where a number of reorientations corresponds to 0), “ [symbol] ” is displayed in area 1 (an area where a number of reorientations corresponds to 1), “ [symbol] ” is displayed in area 2 (an area where a number of reorientations corresponds to 2), and “ [symbol] ” is displayed in area 3 (an area where a number of reorientations corresponds to 3).

The case in which a single Character Input Area (CIA) is allocated in the character input screen 200 has been described. Hereinafter, a case in which 2 Character Input Areas (CIA) are allocated in the character input screen 200 will be described.

FIG. 9 illustrates the character input screen 200 in which a first character input area (CIA 1) and a second character input area (CIA 2) are allocated.

As illustrated in FIG. 9, since the first character input area (CIA 1) and the second character input area (CIA 2) are allocated in the character input screen 200, a user touches the first character input area (CIA 1) with the thumb of the left hand and touches the second character input area (CIA 2) with the thumb of the right hand in a state in which the user holds the terminal 100 with both hands and thus, may promptly input characters.

FIG. 10 illustrates the character input screen 200 that further displays 8 touch guide indicators (TGI 1, TGI 2, TGI 3, TGI 4, TGI 5, TGI 6, TGI 7, and TGI 8) where consonants, vowels and function keys (↑, →, ↓, ←) are displayed around the circumference of each of the 2 Character Input Areas (CIA 1 and CIA 2).

As illustrated in FIG. 10 (a), the character input screen management unit 140 displays 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the first character input area (CIA 1) located on the left side.

Also, the character input screen management unit 140 displays 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the second character input area (CIA 2) located on the right side.

Referring to FIG. 10 (b), the character input screen management unit 140 displays characters (consonants or vowels) and 4 function keys (↑, ↓, →, ←) in each of the 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the first character input area (CIA 1).

Also, the character input screen management unit 140 displays characters (consonants or vowels) and 4 function keys (↑, ↓, →, ←) in each of the 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the second character input area (CIA 2).

Referring to FIG. 10 (b), the locations of all the characters and the function keys displayed in the 8 touch guide indicators (TGI 1, TGI 2, TGI 3, TGI 4, TGI 5, TGI 6, TGI 7, and TGI 8) located in 8 different directions (up, upper-right, right, lower-right, down, lower-left, left, upper-left) from the center of the second character input area (CIA 2) are identical to the locations of all the characters and the function keys displayed in 8 touch guide indicators (TGI 1, TGI 2, TGI 3, TGI 4, TGI 5, TGI 6, TGI 7, and TGI 8) located in 8 different directions (up, upper-right, right, lower-right, down, lower-left, left, upper-left) from the center of the Character Input Area (CIA) of FIG. 8 (b).

As illustrated in FIG. 10 (b), all the characters ( [symbol] [symbol] [symbol] ) and the function keys (↑, →, ↓, ←) displayed in the 8 touch guide indicators (TGI 1, TGI 2, TGI 3, TGI 4, TGI 5, TGI 6, TGI 7, and TGI 8) located in 8 different directions (up, upper-right, right, lower-right, down, lower-left, left, upper-left) from the center of the first character input area (CIA 1) are identical to all the characters ( [symbol] [symbol] [symbol] [symbol] ) and the function keys (↑, →, ↓, ←) displayed in 8 touch guide indicators (TGI 1, TGI 2, TGI 3, TGI 4, TGI 5, TGI 6, TGI 7, and TGI 8) located in 8 different directions from the center of the second character input area (CIA 2).

In the 8 touch guide indicators displayed in surroundings or around the circumference of the first character input area (CIA 1) and in the 8 touch guide indicators displayed in surroundings or around the circumference of the second character input area (CIA 2), the characters are displayed based on a broken line according to a symmetrical character displaying scheme.

Based on the symmetrical character displaying scheme, TGI 4 in the first character input area (CIA 1) and TGI 6 in the second character input area (CIA 2) are touch guide indicators which are symmetric about a broken line, as in the example of FIG. 10 (b). In TGI 4 of the first character input area (CIA 1) and TGI 6 of the second character input area (CIA 2) which are symmetric, identical characters ( [symbol] , [symbol] , [symbol] , and [symbol] ) area displayed.

As described above, by displaying characters (excluding function keys) based on the symmetrical character displaying scheme, the 8 touch guide indicators displayed in surroundings or around the circumference of the first character input area (CIA 1) and the 8 touch guide indicators displayed in surroundings or around the circumference of the second character input area (CIA 2) may be a left keypad and a right keypad which are symmetrical to each other. When the user sets the identical key set for the left and right keypads and performs inputting, the user may not be confused when entering an identical word.

For example, two thumbs are in a form of [symbol] (human) when the user holds the terminal 100, and the user needs to provide a sliding touch with the thumb of the left hand in a right-upward direction and needs to provide a sliding touch with the thumb of the right hand in a left-upward direction to input “ [symbol] ”. However, they are identical in a sense that both the thumb of the left, hand and the thumb of the right hand provide a touch in a direction in which it becomes far from the 4 remaining fingers and thus, confusion may be removed.

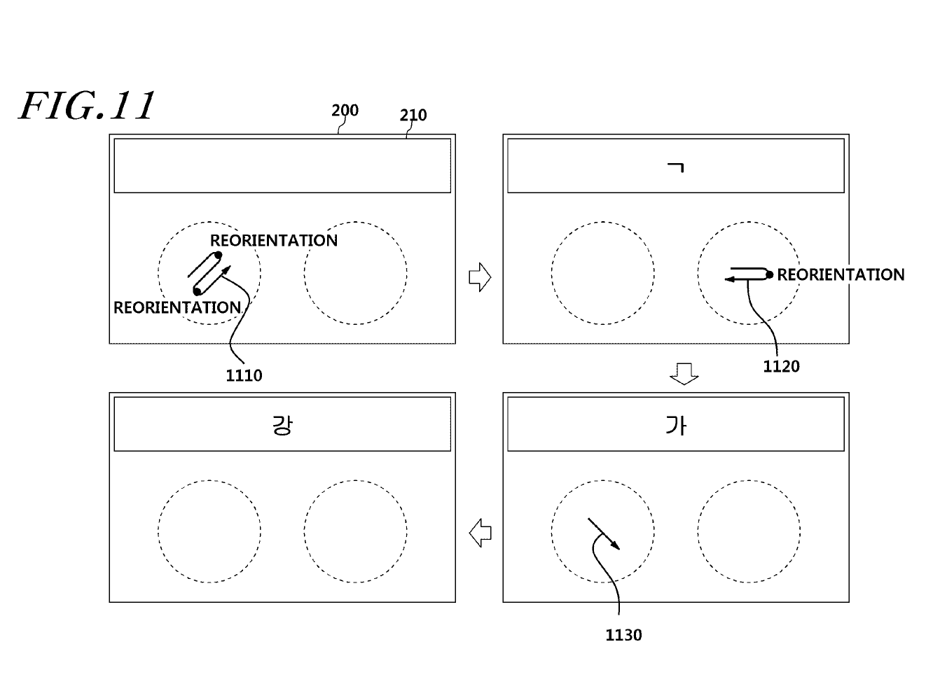

FIG. 11 illustrates a method of inputting a Hangul word in a character input screen including 2 character input areas.

FIG. 11 illustrates a scheme in which a user holds the terminal 100 with both hands, touches a first character input area (CIA 1) with the thumb of the left hand, and touches a second character input area (CIA 2) with the thumb of the right hand, so as to input a Hangul word of “ [symbol] ”. An example in which the first character input area (CIA 1) and the second character input area (CIA 2) are alternately used will be described.

First, as illustrated in FIG. 10 (b), to input a consonant “ [symbol] ”, a sliding touch 1110 needs to be provided [symbol] in a manner that initially slides in a right-upward direction by touching the first character input area (CIA 1) with the thumb of the left hand, slides by executing 2 reorientations in a state of maintaining the touch, and finishes the touch.

Subsequently, as illustrated in FIG. 10 (b), to input a vowel “ [symbol] ” a sliding touch 1120 needs to be provided in a manner that initially slides to the right direction by touching the second character input area (CIA 2) with the thumb of the right hand, slides by executing 1 reorientation in a state of maintaining the touch, and finishes the touch.

Finally, as illustrated in FIG. 10 (b), to input a consonant “ [symbol] ”, a sliding touch 1130 needs to be provided in a manner that initially slides in a right-downward direction by touching the first character input area (CIA 1) with the thumb of the left hand, slides without reorientation, and finishes the touch.

The case in which an identical character is displayed in the 8 touch guide indicators displayed in surroundings or around the circumference of the first character input area (CIA 1) and in the 8 touch guide indicators displayed in surroundings or around the circumference of the second character input area (CIA 2) has been described with reference to FIGS. 10 and 11. Hereinafter, a case in which different characters are displayed in the 8 touch guide indicators displayed in surroundings or around the circumference of the first character input area (CIA 1) and in the 8 touch guide indicators displayed in surroundings or around the circumference of the second character input area (CIA 2) will be described with reference to FIGS. 12 through 14.

In FIGS. 12 through 14, the first character input area (CIA 1) corresponds to a character input area for inputting a consonant and thus, may be referred to as a “consonant input area”, and the second character input area (CIA 2) corresponds to a vowel input area for inputting a vowel and thus, may be referred to as a “vowel input area”.

The first character input area (CIA 1) is used as the consonant input area, and the second character input area (CIA 2) is used as the vowel input area since the consonants of Hangul are generally placed on the left side and the vowels are placed on the right side according to the Hangul system. Therefore, the user may intuitively input characters.

FIG. 12 illustrates a table in which consonants are matched to sliding touch patterns and a table in which vowels are matched to sliding touch patterns, when 2 character input areas (CIA 1 and CIA 2) are a consonant input area and a vowel input area.

As illustrated in FIG. 12 (a), in the table for inputting a consonant, original orientation information and reorientation number information are matched to a sliding touch defined for each constant and stored.

For example, a consonant “ [symbol] ” is matched to original orientation information of an “upward ( [symbol] ) direction” and reorientation number information of “0”. A consonant “ [symbol] ” is matched to oriental orientation information of an “upward ( [symbol] ) direction” and reorientation number information of “1”. A consonant “ [symbol] ” is matched to original orientation information of an “upward ( [symbol] ) direction” and reorientation number information of “2”.

As illustrated in FIG. 12 (a), in the table for inputting a vowel, original orientation information and reorientation number information are matched to a sliding touch defined for each vowel, and stored.

Also, a vowel “ [symbol] ” is matched to original orientation information of a “right-upward ( [symbol] ) direction” and reorientation number information of “0”. The vowel “ [symbol] ” is matched to original orientation information of an “upward ( [symbol] ) direction” and reorientation number information of “1”.

In the two tables of FIG. 12, an arrow displayed in a touch field may not need to be stored in the table, but a sliding touch motion of a user based on original orientation information and a number of reorientations is schematically illustrated in a form of an arrow.

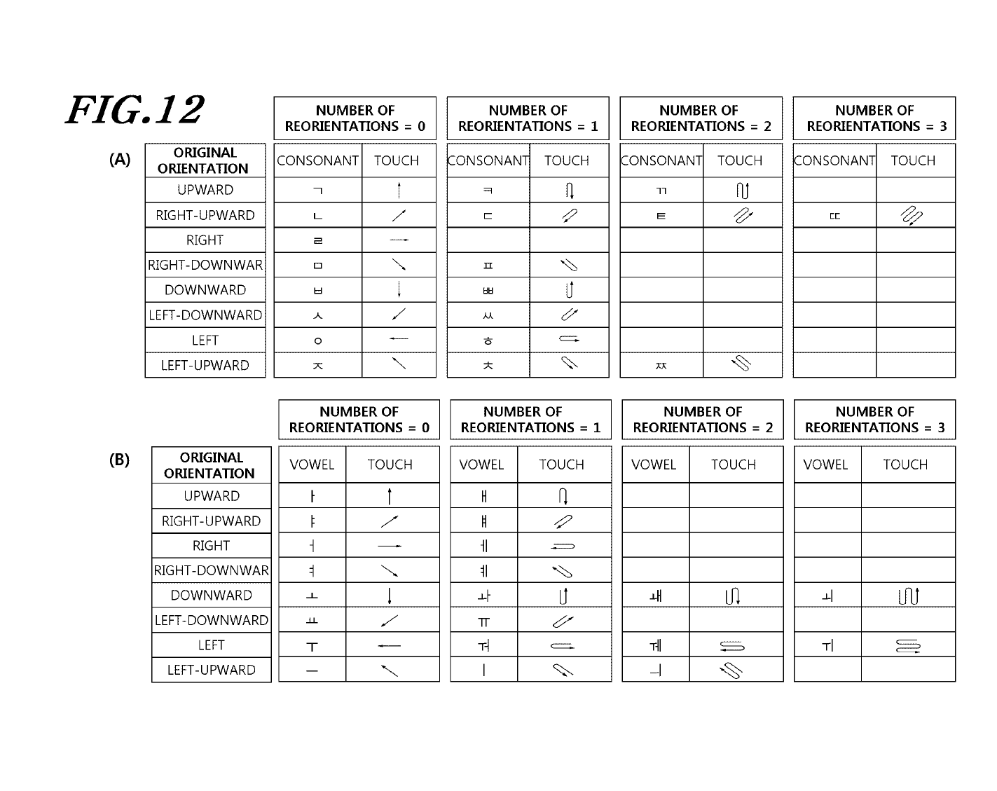

FIG. 13 illustrates a method of inputting a Hangul word, when 2 character input areas are a consonant input area and a vowel input area.

FIG. 13 illustrates a scheme in which a user holds the terminal 100 with both hands, touches the consonant input area (CIA 1) with the thumb of the left hand, and touches the vowel input area (CIA 2) with the thumb of the right hand, to input a Hangul word of “ [symbol] ”.

First, as original orientation information is defined to be an upward direction and reorientation number information is defined to be 2 for “ [symbol] ” In the table of FIG. 12 (a), a sliding touch 1310 may be provided in a manner that initially slides in an upward direction by touching the consonant input area (CIA 1), slides by executing 2 reorientations in a state of maintaining the touch, and finishes the touch, so as to input a consonant “ [symbol] ”.

Subsequently, as original orientation information is defined to be a downward direction and reorientation number information is defined to be 0 for “ [symbol] ” in the table of FIG. 12 (b), a sliding touch 1320 may be provided in a manner that slides in a downward direction by touching the vowel input area (CIA 2), and finishes the touch without reorientation, so as to input a vowel “ [symbol] ”.

Finally, as original orientation information is defined to be a left-upward direction and reorientation number information is defined to be 1 for “ [symbol] ” in the table of FIG. 12 (a), a sliding touch 1330 may be provided in a manner that initially slides in a left-upward direction by touching the consonant input area (CIA 1), slides by executing 1 reorientation in a state of maintaining the touch, and finishes the touch, so as to input a consonant “ [symbol] ”.

When a user memorizes sliding touch pattern information (original orientation information and reorientation number information) matched to each consonant and vowel in the tables of FIGS. 12 (a) and (b), for inputting a desired character, the user may input characters without viewing the character input screen 200.

To intuitively inform a user of sliding touch pattern information (original orientation information and reorientation number information) matched to each consonant and vowel in the tables of FIGS. 12 (a) and (b), a plurality of touch guide indicators (TGI) may be further displayed in surroundings or around the circumference of each of the consonant input area (CIA 1) and the vowel input area (CIA 2).

FIG. 14 illustrates the character input screen 200 that further displays 8 touch guide indicators (TGI 1, TGI 2, TGI 3, TGI 4, TGI 5, TGI 6, TGI 7, and TGI 8) including consonants, in surroundings of the consonant input area (CIA 1), and further displays 8 touch guide indicators (TGI 1, TGI 2, TGI 3, TGI 4, TGI 5, TGI 6, TGI 7, and TGI 8) including vowels, in surroundings of the vowel input area (CIA 2).

Referring to FIG. 14 (a), the character input screen management unit 140 displays 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the consonant input area (CIA 1).

Also, the character input screen management unit 140 displays 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the vowel input area (CIA 2).

Referring to FIG. 14(b), the character input screen management unit 140 displays a consonant to each of the 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the consonant input area (CIA 1). The displayed consonant is determined based on the table illustrated in FIG. 13 (a).

For example, in the consonant input area (CIA 1), TGI 1 is located in the upper portion from the center of the consonant input area (CIA 1) and thus, “ [symbol] , [symbol] , [symbol] ” of which original orientation information corresponds to an upward direction may be displayed in TGI 1, referring to the table of FIG. 13 (a). In this example, TGI 1 is divided into 4 areas (area 0, area 1, area 2, and area 3), and characters are sequentially displayed in area 0, area 1, and area 2, area 3, and area 4, in order of lowest reorientation number information. That is, in TGI 1, “ [symbol] ” is displayed in area 0 (an area where a number of reorientations corresponds to 0), “ [symbol] ” is displayed in area 1 (an area where a number of reorientations corresponds to 1), and “ [symbol] ” is displayed in area 2 (an area where a number of reorientations corresponds to 2).

Also, the character input screen management unit 140 displays a vowel in each of the 8 touch guide indicators (TGI 1, TGI 2, TGI 3, TGI 4, TGI 5, TGI 6, TGI 7, and TGI 8) which are located in 8 different directions (up, upper-right, right, lower-right, down, lower-left, left, upper-left) from the center of the vowel input area (CIA 2). The displayed vowel is determined based on the table illustrated in FIG. 13 (b).

For example, in the vowel input area (CIA 2), TGI 2 is located in the upper-right portion from the center of the vowel input area (CIA 2) and thus, “ [symbol] and [symbol] ” of which original orientation information corresponds to a right-upward direction may be displayed in TGI 2, referring to the table of FIG. 13 (b). In this example, TGI 2 is divided into 4 areas (area 0, area 1, area 2, and area 3), and characters are displayed in the area 0, area 1, and area 2, area 3, and area 4, in order of lowest reorientation number information. That is, in TGI 1, “ [symbol] ” is displayed in area 0 (an area where a number of reorientations corresponds to 0), and “ [symbol] ” is displayed in area 1 (an area where a number of reorientations corresponds to 1).

As described above, a additional function such as a character erasing function (backspace function), a spacing function (a space function), a line changing function (enter function), a shift key (Shift Key) function and the like and/or an input mode switching function may be implemented by allocating a corresponding additional function to a plurality of touch guide indicators (referring to FIG. 8 and FIG. 10), or may be provided by distinguishing from general character inputting based on a location of a touch generated or a type of a touch.

FIG. 15 is a diagram illustrating a function executed when a touch excluding a sliding touch is generated in a character input area or when a touch is generated outside the character input area.

Referring to FIG. 15, when a user touches a point (Pin) inside a character input area (CIA 1 or CIA 2) and the type of the touch is different from a sliding touch, the terminal 100 provides a additional function including one or more functions from among a character erasing function (a backspace function), a spacing function (a space function), a line changing function (an enter function), and a shift key (Shift Key) function, or provides an input mode switching function that switches the type of input character.

Also, referring to FIG. 15, when the user touches a point (Pₒᵤₜ) outside the character input area (CIA 1 or CIA 2) and a type of the touch is different from a sliding touch, the terminal 100 provides a additional function including one or more functions from among a character erasing function (a backspace function), a spacing function (a space function), a line changing function (an enter function), and a shift key (Shift Key) function, or provides an input mode switching function that switches the type of input character.

The character input method provided by the terminal 100 that has been described above will be briefly described again with reference to the flowchart of FIG. 16.

FIG. 16 is a flowchart of a character input method according to an embodiment of the present invention.

Referring to FIG. 16, a method for the terminal 100 according to an embodiment of the present invention to input characters includes a step S1600 of recognizing one or more pieces of information from among original orientation information and reorientation number information for a sliding touch of a user on a touch screen, a step S1602 of determining, to be an input character, a character allocated to correspond to one or more pieces of recognized information from among the original orientation information and reorientation number information, a step S1604 of processing the input of the character determined to be the input character, and the like.

The character input method according to an embodiment of the present invention may be implemented by an application basically installed in the terminal 100 (including programs included in a platform, an operating system, or the like that is basically installed in the terminal 100), or may be implemented by an application (that is, a program) that is directly installed by a user in the terminal 100 through an application provider server such as an application store server, a web server related to an application or a corresponding service, and the like.

In this respect, the character input method according to an embodiment of the present invention may be implemented by an application (that is, a program) that is basically installed in the terminal 100 or directly installed by the user, and may be recorded in a computer readable recording medium of the terminal 100 and the like.

A program that implements the character input method according to an embodiment of the present invention implements a function of recognizing one or more pieces of information from among original orientation information and reorientation number information for a sliding touch of a user on a touch screen, and a function of determining, to be an input character, a character allocated to correspond to one or more pieces of recognized information from among the original orientation information and the reorientation number information, and the like.

The program may be recorded in a computer readable recording medium and may be implemented by a computer and thus, the above described functions may be implemented.

As described above, to enable the computer to read a program recorded in the recording medium and to implement the character input method according to an embodiment of the present invention embodied by the program, the described program may include a code that is coded into a computer language such as C, C++, JAVA, a machine language, and the like which is readable by a processor (CPU) of the computer.

The code may include a function code associated with a function that defines the described functions and the like, and may include an implementation process control code that may be required for the processor of the computer to implement the described functions based on a predetermined process.

Also, the code may further include a memory reference code indicating a location (address number) of an internal or external memory of the computer where the processor of the computer may refer to additional information or media required to implement the described functions.

Also, when the processor of the computer needs to communicate with another computer, a server, or the like placed in a remote location for implementing the described functions, the code may further include a communication code indicating a communication method on how to communicate with the other computer, the server, or the like placed in the remote location using a communication module (for example, a wired and/or wireless communication module) of the computer, information or media to be transmitted or received during the communication, and the like.

Functional programs for implementing the present invention, codes and code segments associated with the same, and the like may be readily inferred or modified by programmers in the art of the present invention by taking into consideration a system environment of the computer that reads a recording medium and implements a program, and the like.

The computer-readable recording medium that records the program as described above may include for example, a ROM, a RAM, a CD-ROM, a magnetic tape, a floppy disk, an optical media storage device, and the like.

A computer-readable recording medium that records the program as described above may be dispersed in a computer system connected through a network and thus, a computer-readable code may be stored and implemented based on a dispersion method. In this case, one or more of the plurality of dispersed computers may implement a few of the described functions, may transmit a result of the implementation to one or more of the other dispersed computers. Also, the computers that receive the result may implement a few of the described functions and provides a result to other dispersed computers.

In particular, a computer-readable recording medium that records an application which is a program for implementing the character input method according to an embodiment of the present invention may be a storage medium (for example, a hard disk and the like) included in an application provider server such as an application store server, a web server associated with an application or a corresponding service, and the like, or may be the application provider server itself.

A computer that is capable of reading a recording medium that records an application which is a program for implementing the character input method according to an embodiment of the present invention may include the terminal 100 such as a smart phone, a tablet PC, a PDA (Personal Digital Assistants), a mobile communication terminal and the like, in addition to a general PC such as a general desktop computer, a notebook, and the like, and may be construed to be all devices that are capable of computing.

When the computer that is capable of reading a recording medium that records an application which is a program for implementing the character input method according to an embodiment of the present invention is the terminal 100 such as a smart phone, a tablet PC, a PDA (Personal Digital Assistants), a mobile communication terminal, and the like, the application may be downloaded from the application provider server to a general PC and may be installed in the terminal 100 through a synchronization program.

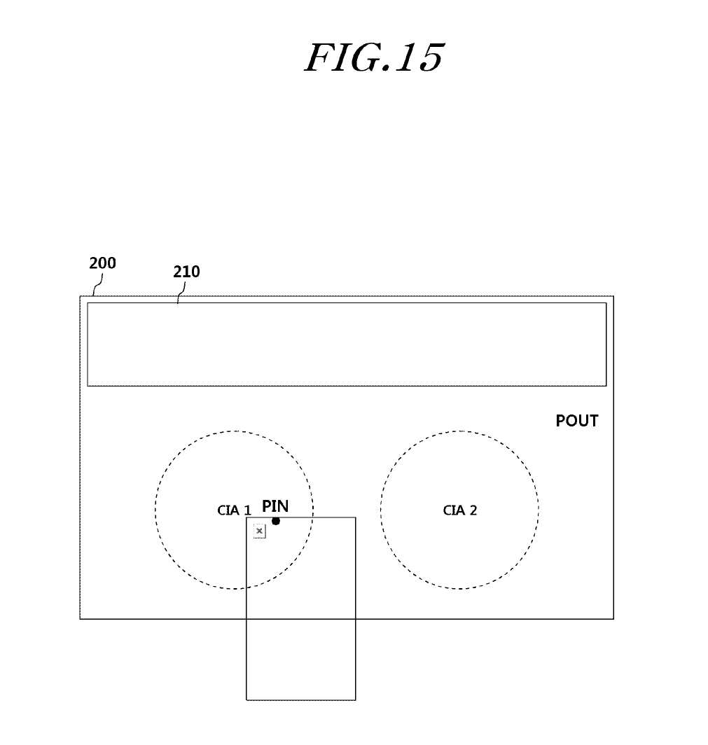

FIG. 17 is a block diagram of a terminal 1700 that inputs characters according to another embodiment of the present invention.

Referring to FIG. 17, the terminal 1700 that inputs characters according to another embodiment of the present invention includes a touch pattern information recognizing unit 1710 that recognizes touch pattern information for a touch of a user on a touch screen, a character input processing unit 1720 that determines, to be an input character, a character matched to the recognized pattern information, referring to matched information between a character and touch pattern information, and processes inputting, and the like.

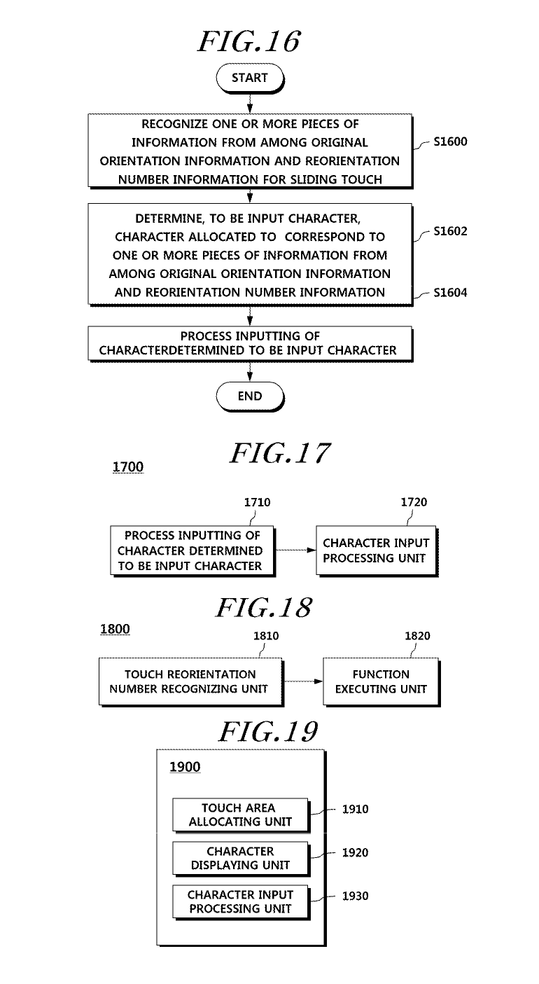

FIG. 18 is a block diagram of a terminal 1800 that inputs characters according to another embodiment of the present invention.

Referring to FIG. 18, the terminal 1800 that inputs characters according to another embodiment of the present invention includes a touch reorientation number recognizing unit 1810 that recognizes a number of reorientations for a touch of a user on a touch screen, a function executing unit 1820 that executes (implements) a function corresponding to the recognized reorientation number information from among the functions defined for respective pieces of reorientation number information, and the like.

A function defined for each reorientation number information may include a character input function, and a function corresponding to the recognized reorientation number information may be a function that inputs a predetermined character.

Referring to FIG. 18, the method for the terminal 1800 according to another embodiment of the present invention to input characters includes a step of recognizing a number of reorientations for a touch of a user on a touch screen, a step of executing (implementing) a function corresponding to the recognized reorientation number information from among the functions defined for respective pieces of reorientation number information, and the like.

Recently, the terminal 1800, such as a smart phone, a tablet PC, a mobile communication terminal, and the like, executes various functions and thus, a touch that distinguishes the execution of each function may be required. However, types of the conventional touch (for example, a tapping touch of a clicking scheme, a dragging touch, a flicking touch and the like) are insufficient to implement many functions executed in the terminal 1800 by distinguishing the functions.

In this example, the insufficient types of touch may be supplemented by using a number of reorientations of a touch as illustrated in FIG. 18.

FIG. 19 is a block diagram of a terminal 1900 that inputs characters according to another embodiment of the present invention.

Referring to FIG. 19, the terminal 1900 that inputs characters according to another embodiment of the present invention includes a touch area allocating unit 1910 that allocates, to a touch screen, a separate touch area (corresponding to the described Character Input Area (CIA)) for inputting characters, a character displaying unit 1920 that displays characters in surroundings or around the circumference of the allocated touch area, wherein the characters are displayed in different locations, and the like.

As described above, a character input screen displayed on the touch screen may be FIG. 5 (b), FIG. 8(b), FIG. 10 (b), or FIG. 14 (b), and in this example, a Touch Guide Indicator (TGI) may be displayed or may not be displayed so that only a character may be displayed.

Referring to FIG. 19, the terminal 1900 that inputs characters according to another embodiment of the present invention further includes a character input processing unit 1930 that determines, to be an input character, a character displayed in a location corresponding to a direction of a recognized touch when the touch of a user is recognized in a touch area, and processes inputting.

The described character displaying unit 1920 displays a plurality of touch guide indicators located in different orientations from the center of the character input area which is a separate touch area for inputting characters, and displays a character in each of the plurality of touch guide indicators.

Therefore, the character input processing unit 1930 selects a predetermined touch guide indicator located in an orientation corresponding to a direction of the recognized touch, determines, to be an input character, a character displayed in the predetermined touch guide indicator, and processes inputting.

When a plurality of characters is displayed in an identical location, the plurality of characters may be matched to different reorientation number information. Accordingly, the character input processing unit 1930 determines one of the plurality of characters to be the input character based on a number of reorientations of the recognized touch, and processes inputting.

When the plurality of characters are displayed in the predetermined touch guide indicator, the described character input processing unit 1930 selects a predetermined touch guide indicator located in an orientation corresponding to a direction of the recognized touch, determines one of the plurality of characters displayed in the predetermined touch guide indicator based on the number of reorientations of the recognized touch.

The described character displaying unit 1920 divides a predetermined touch guide indicator into a plurality of areas and displays a plurality of characters in each of the plurality of areas. Here, each of the plurality of areas may be matched to a corresponding number of reorientations of a touch.

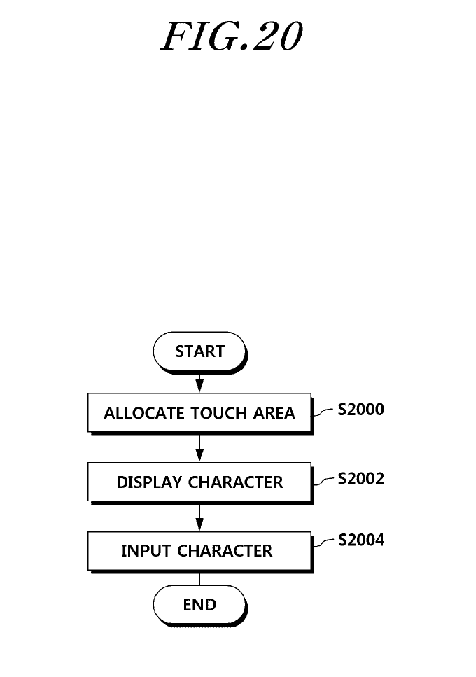

Hereinafter, a method for the terminal 1900 which has been described with reference to FIG. 19 according to another embodiment of the present invention to input characters will be briefly described with reference to FIG. 20.

FIG. 20 is a flowchart of a character input method according to another embodiment of the present invention.

Referring to FIG. 20, the method for the terminal 1900 according to another embodiment of the present invention to input characters includes a step S2000 of allocating a separate touch area for inputting characters to a touch screen, a step S2002 of displaying characters in surroundings or around the circumference of the allocated touch area, to be placed in different positions, and the like

Referring to FIG. 20, the method for the terminal 1900 according to another embodiment of the present invention to input characters further includes a step S2004 of determining a character displayed in a location corresponding to a direction of the recognized touch to be an input character, and processing inputting, when the touch of a user is recognized in a touch area. The character inputting method according to embodiments of the present invention may be implemented by an application basically installed in a terminal (including programs included in a platform, an operating system, or the like that is basically installed in a terminal), or may be implemented by an application (that is, a program) that is directly installed by a user in a terminal through an application provider server such as an application store server, a web server related to an application or a corresponding service, and the like.

In this respect, the character input method according to embodiments of the present invention may be implemented by an application (that is, a program) that is basically installed in a terminal or directly installed by the user, and may be recorded in a computer readable recording medium of a terminal and the like.

The program that implements the character input method according to an embodiment of the present invention may execute a function of allocating a separate touch area for inputting characters to a touch screen, and a function of displaying characters in surroundings or around the circumference of the allocated touch area and displaying the characters in different locations, and the like.

Also, the program that implements the character input method according to an embodiment of the present invention may execute a function of recognizing a number of reorientations for a touch of a user on a touch screen, and a function of executing a process corresponding to recognized reorientation number information from among functions defined for respective pieces of reorientation number information, and the like.

The program may be recorded in a computer readable recording medium and may be implemented by a computer and thus, the above described functions may be implemented.

As described above, to enable the computer to read a program recorded in the recording medium and to implement the character input method according to an embodiment of the present invention embodied by the program, the described program may include a code that is coded into a computer language such as C, C++, JAVA, a machine language, and the like which is readable by a processor (CPU) of the computer.

The code may include a function code associated with a function that defines the described functions and the like, and may include an implementation process control code that may be required for the processor of the computer to implement the described functions based on a predetermined process.

Also, the code may further include a memory reference code indicating a location (address number) of an internal or external memory of the computer where the processor of the computer may refer to additional information or media required to implement the described functions.

Also, when the processor of the computer needs to communicate with another computer, a server, or the like placed in a remote location for implementing the described functions, the code may further include a communication code indicating a communication method how to communicate with the other computer, the server, or the like placed in the remote location using a communication module (for example, a wired and/or wireless communication module) of the computer, information or media to be transmitted or received during the communication, and the like.

Functional programs for implementing the present invention, codes and code segments associated with the same, and the like may be readily inferred or modified by programmers in the art of the present invention by taking into consideration a system environment of the computer that reads a recording medium and implements a program, and the like.

The computer-readable recording medium that records the program as described above, include, for example, a ROM, a RAM, a CD-ROM, a magnetic tape, a floppy disk, optical media storage device, and the like.

A computer-readable recording medium that records the program as described above may be dispersed in a computer system connected through a network and thus, a computer-readable code may be stored and implemented based on a dispersion method. In this case, one or more of the plurality of dispersed computers may implement a few of the described functions, may transmit a result of the implementation to one or more of the other dispersed computers. Also, the computers that receive the result may implement a few of the described functions and provides a result to other dispersed computers.

In particular, a computer-readable recording medium that records an application which is a program for implementing the character input method according to an embodiment of the present invention may be a storage medium (for example, a hard disk and the like) included in an application provider server such as an application store server, a web server associated with an application or a corresponding service, and the like, or may be the application provider server itself.

A computer that is capable of reading a recording medium that records an application which is a program for implementing the character input method according to an embodiment of the present invention may include the terminal 100 such as a smart phone, a tablet PC, a PDA (Personal Digital Assistants), a mobile communication terminal and the like in addition to a general PC such as a general desktop computer, a notebook, and the like, and may be construed to be all devices that are capable of computing.

When the computer that is capable of reading a recording medium that records an application which is a program for implementing the character input method according to an embodiment of the present invention is the terminal 100 such as a smart phone, a tablet PC, a PDA (Personal Digital Assistants), a mobile communication terminal, and the like, the application may be downloaded from the application provider server to a general PC and may be installed in the terminal 100 through a synchronization program.

As described above, according to the present invention, there is provided a character input technology for a user to input characters without viewing a screen.

Also, according to the present invention, a character input technology for maximally reducing a probability of a typographic error while characters are input.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more pieces of hardware. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, or the like may be employed as the storage medium of a computer program.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although the embodiments of the present invention have been described for illustrative purposes, those skilled in the art will appreciate that various modifications, additions and substitutions are possible, without departing from the scope and spirit of the invention. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

### CROSS-REFERENCE TO RELATED APPLICATION

This application claims priority from and the benefit under 35 U.S.C. §119(a) of Korean Patent Application No. 10-2011-0072979, filed on Jul. 22, 2011 which is hereby incorporated by reference for all purposes as if fully set forth herein. Also, when this application claims the priority benefit of the same Korean Patent Application from countries in addition to the U.S., the disclosure will be incorporated herein by reference.

1. A terminal for inputting characters, the terminal comprising:
a touch recognition unit that recognizes one or more pieces of information from among original orientation information and reorientation number information for a sliding touch of a user on a touch screen; and
a character input processing unit that determines, to be an input character, a character allocated to correspond to the one or more pieces of recognized information from among the original orientation information and reorientation number information, and processes inputting.

2. The terminal as claimed in claim 1, further comprising:
a character allocation management unit that matches, to each character, original orientation information and reorientation number information for a sliding touch required for inputting a corresponding character, and stores and manages matched information as a table.

3. The terminal as claimed in claim 2, wherein, in the table that is stored and managed by the character allocation management unit, one or more pieces of information from among original orientation information and reorientation number information corresponding to a character is different from one or more pieces of information from among original orientation information and reorientation number information corresponding to another character.

4. The terminal as claimed in claim 1, further comprising:
a character input screen management unit that allocates a character input area to a character input screen of the touch screen, as a separate touch area for a sliding touch of a user, and displays a plurality of touch guide indicators for guiding about original orientation information and reorientation number information for the sliding touch of the user in surroundings or around the circumference of the character input area.

5. The terminal as claimed in claim 4, wherein the character input screen management unit displays the plurality of touch guide indicators to be located in different directions from the center of the character input area, and displays a character in each of the plurality of touch guide indicators.

6. The terminal as claimed in claim 5, wherein the character input processing unit determines, from among the plurality of touch guide indicators, a predetermined touch guide indicator located in a direction corresponding to original orientation information for a sliding touch recognized in the character input area, determines, to be an input character, a character displayed in the determined predetermined touch guide indicator, and processes inputting.

7. The terminal as claimed in claim 6, wherein the character input processing unit determines, from among the plurality of touch guide indicators, a predetermined touch guide indicator located in a direction corresponding to original orientation information for a sliding touch recognized in the character input area, and
when a plurality of characters are displayed on the determined predetermined touch guide indicator, determines, from among the plurality of characters, a character corresponding to reorientation number information for the sliding touch recognized in the character input area to be an input character, and processes inputting.

8. The terminal as claimed in claim 5, wherein the character input screen management unit allocates a plurality of character input areas to the touch screen and displays the same to be recognized, and displays a plurality of touch guide indicators in surroundings or around the circumference of each of the plurality of character input areas.

9. The terminal as claimed in claim 8, wherein the character input screen management unit displays characters of a first character group in a plurality of touch guide indicators displayed in surroundings or around the circumference of a first character input area of the plurality of character input areas, displays characters of a second character group that is different from the first character group, in a plurality of touch guide indicators displayed in surroundings or around the circumference of a second character input area of the plurality of character input areas, or symmetrically displays identical characters in the plurality of touch guide indicators displayed in the surroundings or around the circumference of the first character input area of the plurality of character input areas and in the plurality of touch guide indicators displayed in the surroundings or around the circumference of the second character input area of the plurality of character input areas.

10. The terminal as claimed in claim 4, further comprising:
an input mode switching unit that switches the type of an input character when a type of a touch generated in the character input area is recognized by the touch recognition unit to be different from a sliding touch, or when a touch generated outside the character input area is recognized; and
a additional function processing unit that processes one or more functions from among a character erasing function, a spacing function, a line changing function, and a shift key function when a type of a touch generated in the character input area is recognized by the touch recognition unit to be different from a sliding touch, or when a touch generated outside the character input area is recognized

11. The terminal as claimed in claim 4, wherein the character input screen management unit displays a function key in one or more touch guide indicators from among the plurality of touch guide indicators.

12. The terminal as claimed in claim 11, further comprising:
a additional function processing unit that performs:
allocating a shift key (Shift Key) in a touch guide indicator displayed in a first direction from the center of the character input area, and executing a shift key (Shift Key) function when an original orientation for a sliding touch is recognized to be the first direction from among the first through fourth directions including the upward ( [symbol] ), downward ( [symbol] ), left ( [symbol] ) and right ( [symbol] ) directions;
allocating an enter key (Enter Key) in a touch guide indicator displayed in a second direction from the center of the character input area, and executing an enter key (Enter Key) function when the original orientation for the sliding touch is recognized to be the second direction;
allocating a backspace key (Backspace Key) in a touch guide indicator displayed in a third direction from the center of the character input area, and executing a backspace key (Backspace Key) function when the original orientation for the sliding touch is recognized to be the third direction; and
allocating a space key (Space Key) in a touch guide indicator displayed in a fourth direction from the center of the character input area, and executing a space key (Space Key) function when the original orientation for the sliding touch is recognized to be the fourth direction.

13. A method for a terminal to input characters, the method comprising:
allocating, to a touch screen, a separate touch area for inputting characters; and
displaying characters in surroundings or around the circumference of the allocated touch area, and displaying the characters in different locations.

14. The method as claimed in claim 13, wherein, when a touch of a user is recognized in the touch area, the method further comprises:
determining, to be an input character, a character displayed in a location corresponding to a direction of the recognized touch, and processing inputting.

15. A computer-readable recording medium which records a program for implementing a method for inputting characters, the computer-readable recording medium implementing:
a function of recognizing a number of reorientations associated with a touch of a user on a touch screen; and
a function of executing a process corresponding to the recognized reorientation number information from among functions defined for respective pieces of reorientation number information.
